(19) United States
(12) Patent Application Publication
(10) Pub. No.: US 2024/0014607 A1
(43) Pub. Date: Jan. 11, 2024

(54) WIRE TO EDGE CARD CONNECTOR APPARATUS AND METHOD

(71) Applicant: Samtec, Inc., New Albany, IN (US)

(72) Inventor: Thomas A. Hall, III, New Albany, IN (US)

(21) Appl. No.: 18/345,756

(22) Filed: Jun. 30, 2023

Related U.S. Application Data
(60) Provisional application No. 63/359,392, filed on Jul. 8, 2022.

(51) Int. Cl. H01R 13/6592; H01R 12/75; B33Y 80/00

(52) U.S. Cl. CPC H01R 13/6592; H01R 12/75; B33Y 80/00

(57) ABSTRACT

An electrical connector apparatus and method. The electrical connector may include one or more electrically conductive materials. The electrical connector may include one or more receptacles. The one or more electrically conductive materials may include one or more teeth. The electrical connector, or portions thereof, may be made by additive manufacturing.

### BRIEF DESCRIPTION OF OTHER TECHNICAL FEATURES

U.S. Pat. Nos. 2,682,647; 3,706,958 and 6,331,123 are hereby incorporated by reference in their entireties.

### TECHNICAL FIELD

The present embodiments relate generally to an electrical connector.

### BACKGROUND

Typical connectors may require additional material and manufacturing steps for electrical continuity, thereby potentially increasing cost, waste, and/or material to produce. Thus, there is a need to reduce waste and material to efficiently produce the electrical connector.

The present invention is directed at overcoming, or at least improving upon, the disadvantages of the prior art.

### SUMMARY

In some embodiments of the invention, for example, an electrical connector may include an electrically insulative housing. In various embodiments, the electrical connector may include a first electrically conductive material.

In addition, in various embodiments, the first electrically conductive material may be carried by the housing and define at least one electrically conductive first tooth/rib/projection configured to engage with a ground shield of a first cable. In some embodiments, the electrical connector may include a first cable, the first cable comprising a first signal conductor. In various embodiments, the first cable may include a second signal conductor. In some embodiments, the first electrically conductive material may not be compressible, deflectable or both. In various embodiments, at least one electrically conductive first tooth/rib/projection may be angled in an insertion direction of the first cable. In some embodiments, the electrical connector may include a second electrically conductive material carried by the housing that may not be electrically connected to the first electrically conductive material. In various embodiments, the second electrically conductive material may not be compressible, deflectable or both. Moreover, in some embodiments, the electrical connector may include a third electrically conductive material that may not be electrically connected to the first electrically conductive material or the second electrically conductive material. In various embodiments, the housing and the first electrically conductive material may be both printed. In some embodiments, the electrical connector may include one or more spacers. In various embodiments, the electrical connector may include one or more receptacles. In various embodiments, the first electrically conductive material may be fixed in position relative to the housing.

In some embodiments, an electrical connector may include an electrically insulative housing. In various embodiments, the electrical connector may include a non-compressible, first electrically conductive material carried by the housing. In some embodiments, the electrical connector may include a cable. In various embodiments, an interior surface of the first electrically conductive material may define at least one tooth/rib/projection configured to engage a surface of the cable. Moreover, in some embodiments, the first electrically conductive material may surround the cable.

In addition, in some embodiments, an electrical connector may include a housing. In various embodiments, the electrical connector may include one or more electrically conductive materials.

In various embodiments, the one or more electrically conductive materials may be fixed relative to the housing. In some embodiments, the one or more electrically conductive materials may include one or more receptacles. In various embodiments, the one or more receptacles may have a discontinuous circumference. In some embodiments, the one or more receptacles may have a continuous circumference. In various embodiments, the one or more electrically conductive materials may include one or more teeth. Moreover, in some embodiments, the electrical connector may include one or more spacers. In various embodiments, the housing and/or the one or more electrically conductive materials may be printed. In some embodiments, one or more electrically conductive materials may not be compressible, deflectable or both. In various embodiments, the electrical connector may include a first cable. Moreover, in some embodiments, the first cable may include one or more signal conductors in both electrical and physically engagement with one or more electrically conductive materials. In various embodiments, the one or more electrically conductive materials may not be electrically connected to each other. In some embodiments, the housing and/or one or more electrically conductive materials may include a plurality of members. In various embodiments, the housing may include one or more receptacles. In some embodiments, the one or more receptacles of the housing may have a discontinuous circumference. In various embodiments, the one or more receptacles of the housing may have a continuous circumference. In some embodiments, the one or more electrically conductive materials may be positioned within one or more receptacles of the housing. In various embodiments, the housing may be electrically non-conductive and/or contains or carries electrically conductive, magnetic absorbing material and/or contains or carries electrically non-conductive, magnetic absorbing material.

### BRIEF DESCRIPTION OF THE ILLUSTRATIONS

In the drawings, like reference characters generally refer to the same parts throughout the different views. Also, the drawings are not necessarily to scale, emphasis instead generally being placed upon illustrating the principles of the invention.

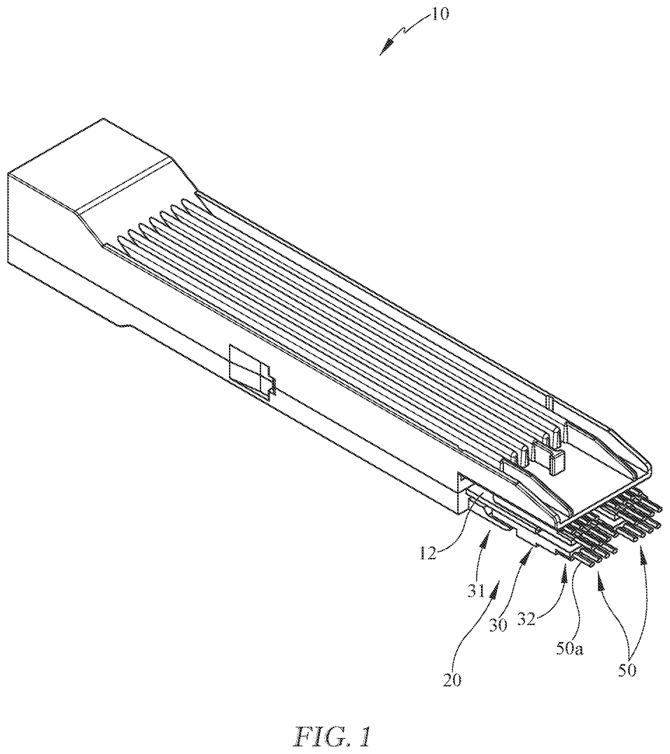

FIG. 1 is a rear perspective view of one embodiment of an electrical connector within a module application.

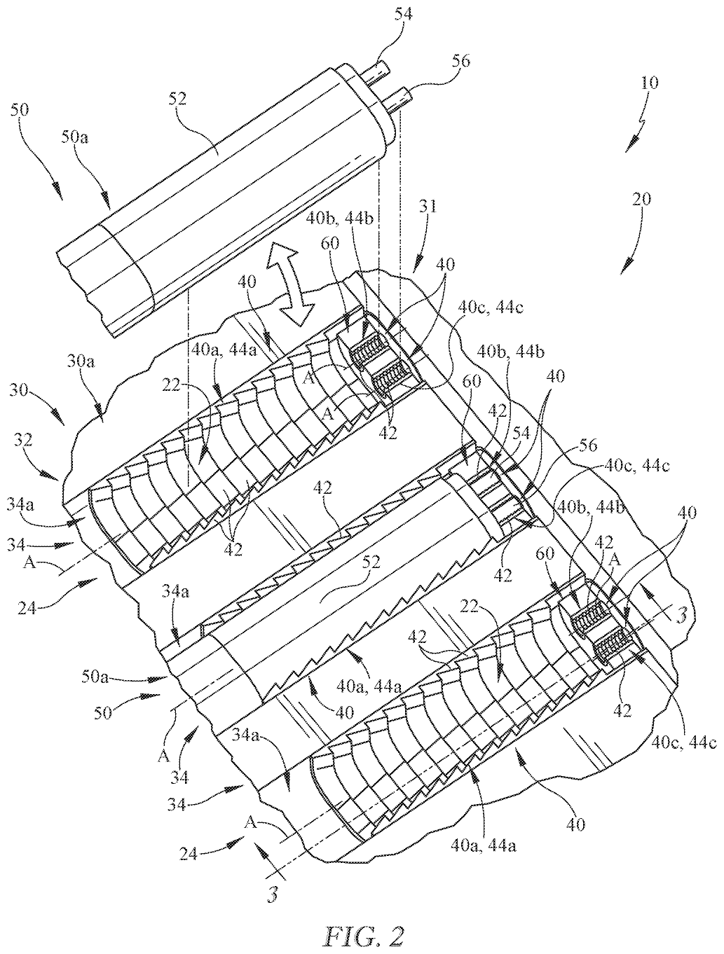

FIG. 2 is an enlarged perspective view of the electrical connector of FIG. 1 illustrating one cable being exploded away from the housing and the electrically conductive material/receptacles, another cable engaging the housing and the electrically conductive material/receptacles, and another cable removed from the housing and the electrically conductive material/receptacles.

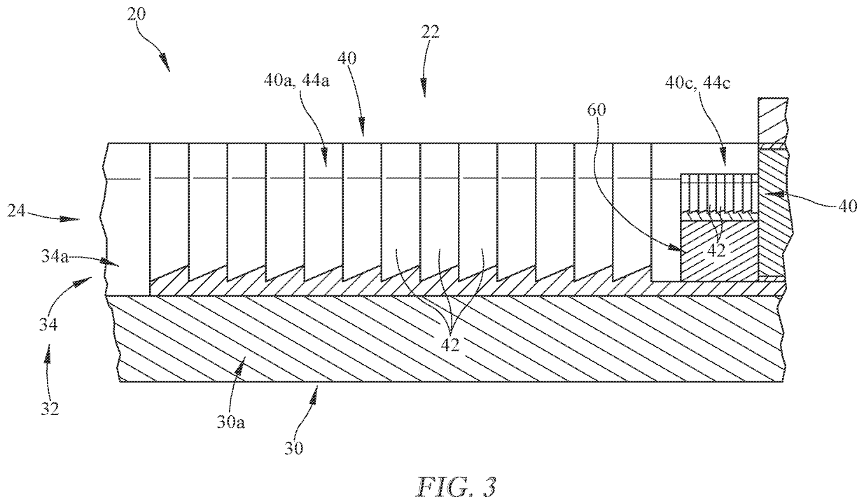

FIG. 3 is a sectional view of the electrical connector of FIG. 2 taken along line 3-3.

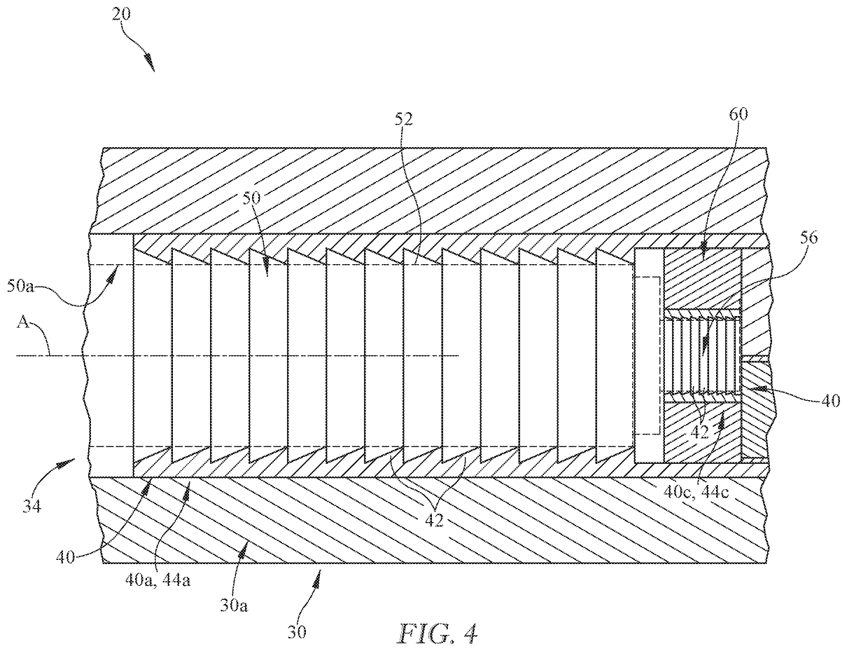

FIG. 4 is a sectional view of another embodiment of the electrical connector printed with the cable in its installed or inserted position, and illustrating the electrical connector circumscribing the entire outer periphery of the cable.

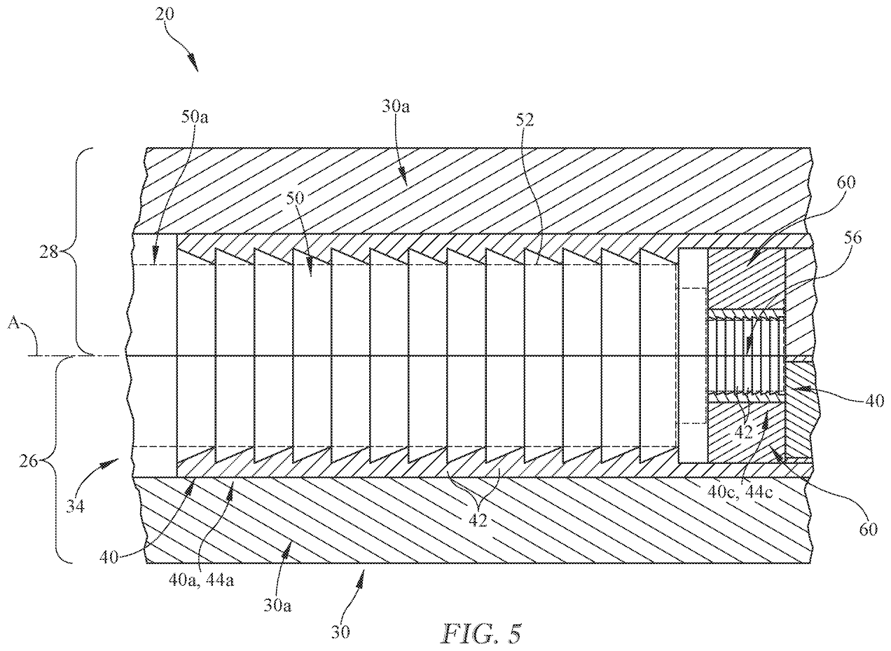

FIG. 5 is a sectional view of another embodiment of the electrical connector printed in at least two members subsequently combined with the cable, and illustrating the electrical connector circumscribing the entire outer periphery of the cable.

### DETAILED DESCRIPTION

Embodiments may further be understood with reference to the various Figures. With reference to Figures, an embodiment provides for one or more electrical connectors 20 for electrical continuity. The one or more electrical connectors 20 may include one or more housings 30 and at least one electrically conductive material/contact/section 40. In some embodiments, the electrical connector 20 may include one or more printed circuit boards 12 and one or more cables 50. The one or more electrical connectors 20 may electrically/physically connect the printed circuit board 12 and one or more cables 50. The one or more electrically conductive materials 40 surround at least a portion of a cable A first cable 50a of the one or more cables 50 may include at least one of a ground shield 52, a first signal conductor 54, and/or a second signal conductor 56. Although the first cable 50a may be a twin axial cable as shown in the one embodiment, it should be understood a variety of cables may be used and still be within the scope of the invention.

The one or more electrical connectors 20, or portions thereof, may be used in a variety of applications or devices. For example, the one or more applications/devices may include, but is not limited to, one or more module interconnects 10 (e.g. a wire to card edge interconnect), a server rack, optical to electrical connectors, etc. Further, for example, the electrical connectors 20 may be used in wire to wire interconnects, wire to board interconnects, and/or splices for twinax or coax cable.

In some implementations, the housing 30 (e.g. electrically insulative) may be defined by one or more members/pieces. As shown in the one embodiment of the Figures, the electrical connector 20, housing 30, or housing body 30a may include a single member. Although the housing 30 or body 30a is shown as a single member in FIGS. 1-4, it should be understood that the electrical connector may be a plurality of members in some embodiments a shown in FIG. 5. The housing 30 may include a first end 31 and an opposing second end 32. The first end 31 may be adjacent to or in electrical communication with the printed circuit board 12 and the second end 32 may be adjacent or in electrical communication with the one or more cables 50.

In some implementations, the electrical connector 20 or housing 30 may include or carry one or more electrically conductive materials 40. The one or more electrically conductive materials 40 may electrically/physically connect to one or more devices (e.g. cable 50, printed circuit board 12, etc.). The one or more electrically conductive materials 40 may extend through or electrically connect the first end 31 to the second end 32 of the housing 30. The one or more electrically conductive materials 40 (e.g. receptacles 44, one or more teeth 42) may be in a fixed position (e.g. axially, radially, rotationally) relative to the housing 30 (e.g. receptacle 34). As shown in the one embodiment in the Figures, the one or more electrically conductive materials 40 may include a first electrically conductive material 40a, a second electrically conductive material 40b, and/or a third electrically conductive material 40c. In some embodiments as shown in the Figures, the electrically conductive materials 40 may not be compressible or may be non-compressible, deflectable or both. In various embodiments, the electrically conductive materials 40 may not be electrically connected to each other. For example, the first electrically conductive material 40a may not be electrically connected to the second electrically conductive material 40b. Further, for example, the third electrically conductive material 40c may not be electrically connected to both the first electrically conductive material 40a or the second electrically conductive material 40b. Alternatively, in some embodiments, two or more electrically conductive materials 40 may be electrically connected to each other. As shown in the one embodiment in the Figures, the first electrically conductive material 40a may electrically/physically engage or connect with the ground shield 52 of the first cable 50a. Further, the second and third electrically conductive materials 40b, 40c may electrically/physically engage or connect with the first signal conductor 54 and the second signal conductor 56, respectively, of the first cable 50a.

In some implementations, the one or more electrically conductive materials 40 (e.g. receptacles 44, materials 40a-40c) may include or define one or more teeth/ribs/projections 42 (e.g. electrically conductive). The teeth 42 may project radially inward from the body or receptacle 44 of the electrically conductive material 40 (e.g. interior surface/periphery). The teeth 42 may be angled in an insertion direction of the first cable or towards the distal free end of the cable 50 within the housing 30/receptacle 34. The plurality of teeth 42 may be aligned in series or spaced along the axis A of the cable 50 or receptacle 44a-44c for one or more lengths. The teeth 42 may circumscribe the cable 50, or portions thereof, for a distance or portion of the circumference/outer periphery. As shown in FIGS. 2 and 3, the teeth or tooth 42 may extend about 180 degrees (e.g. continuously, half) about the cable 50 (e.g. guard shield, first signal conductor, second signal conductor), or portion thereof. In some embodiments as shown in FIGS. 4 and 5, the teeth 42 may extend about 360 degrees or continuously about the cable 50, or portions thereof. It should be understood that the teeth 42 may be a variety of shapes, sizes, quantities, positions within the housing/receptacles, and constructions and still be within the scope of the invention. For example, the teeth may be interrupted about the circumference or stated alternatively as having a plurality of teeth spaced about the circumference, or portion of the circumference. Further, for example, a variety of patterns or textures on the inner periphery of the receptacles or electrically conductive materials may be used alone or in combination with the one or more teeth.

In some implementations, the electrical connector 20, housing 30, or one or more electrically conductive materials 40 may include one or more receptacles/sections/portions 34, 44. The one or more receptacles 34, 44 of the electrically conductive materials/housing 30, 40 may receive the cable (e.g. first cable 50a), or portions thereof (e.g. the first signal conductor, the second signal conductor, the ground shield, etc.). The one or more receptacles 44a-44c may include the one or more teeth 42. The one or more receptacles 34, 44 may be positioned in the second end 32 of the housing 30. The one or more receptacles 34, 44 may each extend for a length (e.g. different, same). In the one embodiment shown in the Figures, the first electrically conductive material 40a may have a first receptacle 44a, the second electrically conductive material 40b may have a second receptacle 44b, and the third electrically conductive material 40c may have a third receptacle 44c. The second and third receptacle 44b, 44c may be positioned at the distal end of the first receptacle 44a along the axis A of the housing receptacle 34. The second and third receptacle 44b, 44c may be parallel to each other. The second and third receptacle 44b, 44c may be axially aligned and positioned at a radial distance within or inwardly from the outer periphery or extent of the first receptacle 44a. The housing 30 may include a fourth receptacle 34a receiving the electrically conductive material (e.g. first 40a, second 40b, and/or third 40c), receptacles (e.g. first 44a, second 44b, and/or third 44c receptacles), and/or cable 50, or portions thereof. Although the one or more receptacles 34, 44 (e.g. electrically conductive material and/or housing) are shown in FIGS. 1-3 with a discontinuous circumference (e.g. about 180 degrees) about its axis, it should be understood that the receptacle 34, 44 (e.g. electrically conductive material and/or housing), or portions thereof, may be of a variety of circumferences (e.g. 360 degrees or continuous circumference, 180 degrees, less than 180 degrees, more than 180 degrees, etc.) about the one or more cables 50, or portions thereof. For example, in some embodiments as shown in FIGS. 4 and 5, the receptacles 34, 44 may extend about 360 degrees or continuously about the cable 50, or portions thereof. The discontinuous periphery or circumference may define a lateral opening 22 into the one or more receptacles 34, 44 (e.g. electrically conductive material and/or housing) and/or connector 20. Further, the one or more receptacles 34, 44 (e.g. electrically conductive material and/or housing) may define an axial/longitudinal opening 24 adjacent the second end 32 of the housing/receptacle into the one or more receptacles 34, 44 (e.g. electrically conductive material and/or housing) and/or connector 20. As shown in the one embodiment of the Figures, each one of the receptacles 44 of the electrically conductive material 40 (e.g. first, second, third) may include the one or more teeth 42, if used. The first receptacle 44a or first electrically conductive material 40a may electrical/physically connect (e.g. press fit) to the ground shield 52. The second receptacle/material 44b, 40b and third receptacle/material 44c, 40c may electrically/physically connect (e.g. press fit) to the first and second signal conductors 54, 56, respectively. The electrical/physical connection between the receptacle 44 and portions of the cable 50 may not need soldering or may be solderless. Alternatively, soldering may be used in some embodiments. It should be understood that the receptacles (e.g. electrically conductive material and/or housing) may be a variety of shapes, sizes, quantities, positions relative to the housing, and constructions and still be within the scope of the invention.

In some implementations, the electrical connector 20, housing 30, receptacle(s) 34, 44, and/or electrically conductive material 40 may include one or more spacers/members 60. The one or more spacers 60 (e.g. made of non-conducting materials) create or maintain one or more spaces or separation between the one or more electrically conductive materials 40/receptacles 44 and/or the cable 50, or portions thereof (e.g. ground shield 52, first signal conductor 54, second signal conductor 56, etc.). As shown in the one embodiment in the Figures, at least one spacer 60 may space the ground shield 52 longitudinally/axially and/or radially from the second and third receptacle 44b, 44c and/or second and third electrically conductive material 40b, 40c. Although the first cable 50a is shown in FIG. 2 to be trimmed or clipped to offset the ground shield 52 from the distal end or spacer 60, the need to clip the first cable may be reduced as a result of the spacer 60 allowing the ground shield to run or contact the spacer 60 directly. The spacer, if used, may also space/offset (e.g. laterally within the first receptacle 44a and/or fourth/housing receptacle 34a) the second and third receptacle 44b, 44c from each other in some embodiments.

In some implementations, the electrical connector 20, housing 30, and/or electrically conductive material 40 may be made by additive manufacturing. For example, in some embodiments, the housing 30 (e.g. body) and/or the one or more electrically conductive materials 40, or portions thereof, may be printed with one or more materials. One such process may be, but is not limited to, material jetting and/or binder jetting. In the one embodiment shown in FIGS. 1-3, both the housing 30 and the one or more electrically conductive materials 40 may be printed together. For example, the nonconductive material (e.g. resin) and/or conductive material (e.g. metal) may be printed together to form the connector 20. The one or more cables 50 are then inserted into the electrical connector 20. In various embodiments, the housing 30 and the one or more electrically conductive materials 40 may be printed in series or after each other. For example, the housing 30 may be printed then the conductive material(s) 40 may be printed directly in the printed housing, or printed and assembled later.

In some embodiments, the electrical connector 20, or portions thereof, may be assembled during printing. For example, the electrical connector 20, or portions thereof, may be partially printed (e.g. first printing) before inserting the one or more cables 50 and continuing to print (e.g. second printing) to complete the printed connector 20. Further, as shown in the one embodiment in FIG. 4, a first portion of the housing 30 and the one or more electrically conductive materials 40 are printed, then the one or more cables 50 are inserted/combined (e.g. into the receptacle(s) 34, 44), and a second portion of the housing and the one or more electrically conductive materials are printed or continued to be printed onto the cable and first printed portion. For example, this embodiment may circumscribe (e.g. 360 degrees) the housing and one or more electrically conductive materials about the cable, or portions thereof. Further, in some embodiments, the one or more members/portions of the electrical connector may be printed and subsequently combined. For example, as shown the one embodiment in FIG. 5, a first member 26 may be printed with the housing and/or electrically conductive material(s) and a second member 28 may be printed with the remaining portion of the housing and/or electrically conductive material(s). The first member 26 and the second member 28 may then be combined with the one or more cables 50. For example, this embodiment may circumscribe (e.g. 360 degrees) the housing and one or more electrically conductive materials about the cable, or portions thereof. In some embodiments, the housing may be printed and the electrically conductive material may not be printed, or vice versa. A variety of printers may be used and still be within the scope of the invention. In some applications the housing, or portions thereof, may be printed using a resin printer, such as an ELEGOO MARS 3 LCD printer, a STRATASYS ORIGIN 1 DLP printer, a PRUSA i3 MK3S+ printer, etc.

The electrical connector, receptacle(s), housing, electrically conductive material(s), or portions thereof, may be of a variety of shapes, profiles, sizes, lengths, quantities, constructions, and materials. The housing 30, or portions thereof, may be made from one or more materials (e.g. non-conductive materials, magnetic absorbing material, or electrically non-conductive, magnetic absorbing material). For example, but is not limited to, a plastic or polymer-based material/resin may be used in some applications of the housing. The electrically conductive material 40, or portions thereof, may be made from one or more materials (e.g. conductive materials, metallic, magnetic absorbing material, or electrically conductive, magnetic absorbing material). For example, but is not limited to, silver (e.g. metallic ink(s)) may be used in some applications of the electrically conductive material. In some embodiment, the housing may be electrically non-conductive and/or contains or carries electrically conductive, magnetic absorbing material and/or contains or carries electrically non-conductive, magnetic absorbing material.

In use, the one or more cables 50 (e.g. first cable 50a, second cable, etc.) may be inserted or received by the one or more receptacles 34, 44 of the housing 30 and/or electrically conductive material(s) 40. In some embodiments, one or more portions of the cable 50 may be cut-away, clipped, or exposed. With the ground shield 52, first signal conductor 54, and/or second signal connector 56 exposed, the cable 50 may be inserted/received/engaged into the electrical connector 20 (e.g. electrically conductive material, receptacle(s)). The one or more teeth 42, if used, may engage (e.g. physically, electrically) or dig into the external surfaces of the ground shield 52 and/or signal conductors 54, 56. In some embodiments as shown in FIG. 2, the cable 50 may be inserted in a lateral direction to the axis A of the receptacles 34, 44 through the lateral opening 22 thereby positioning a remaining portion of the cable 50 through the longitudinal opening 24. Alternatively, the cable 50, or portions thereof, may be inserted axially into the longitudinal opening 24. The electrically conductive material(s) 40 (e.g. first, second, third, etc.) may not be compressed when engaging the cable, or portions thereof. The electrical/physically engagement between the electrically conductive material and the signal conductor and/or ground shield may not be soldered in some embodiments.

While several embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

It is to be understood that the embodiments are not limited in its application to the details of construction and the arrangement of components set forth in the description or illustrated in the drawings. The invention is capable of other embodiments and of being practiced or of being carried out in various ways. Unless limited otherwise, the terms “connected,” “coupled,” “in communication with,” and “mounted,” and variations thereof herein are used broadly and encompass direct and indirect connections, couplings, and mountings. In addition, the terms “connected” and “coupled” and variations thereof are not restricted to physical or mechanical connections or couplings.

The foregoing description of several embodiments of the invention has been presented for purposes of illustration. It is not intended to be exhaustive or to limit the invention to the precise steps and/or forms disclosed, and obviously many modifications and variations are possible in light of the above teaching.

1.-31. (canceled)

32. An electrical connector comprising:
an electrically insulative housing and a first electrically conductive material.

33. The electrical connector of claim 32 wherein the first electrically conductive material is carried by the housing and defines at least one electrically conductive first tooth/rib/projection configured to engage with a ground shield of a first cable.

34. The electrical connector of claim 33 wherein the at least one electrically conductive first tooth/rib/projection is angled in an insertion direction of the first cable.

35. The electrical connector of claim 32 further comprising a first cable, the first cable comprising a first signal conductor.

36. The electrical connector of claim 35 wherein the first cable further comprises a second signal conductor.

37. The electrical connector of claim 32 wherein the first electrically conductive material is not compressible, deflectable or both.

38. The electrical connector of claim 32 further comprising a second electrically conductive material carried by the housing that is not electrically connected to the first electrically conductive material.

39. The electrical connector of claim 38 wherein the second electrically conductive material is not compressible, deflectable or both.

40. The electrical connector of claim 38 further comprising a third electrically conductive material that is not electrically connected to the first electrically conductive material or the second electrically conductive material.

41. The electrical connector of claim 32 wherein the housing and the first electrically conductive material are both printed.

42. The electrical connector of claim 32 further comprising one or more spacers.

43. The electrical connector of claim 32 further comprising one or more receptacles.

44. The electrical connector of claim 32 wherein the first electrically conductive material is fixed in position relative to the housing.

45. An electrical connector comprising:
an electrically insulative housing;
a non-compressible, first electrically conductive material carried by the housing; and
a cable, wherein an interior surface of the first electrically conductive material defines at least one tooth/rib/projection configured to engage a surface of the cable and the first electrically conductive material surrounds the cable.

46. An electrical connector comprising:
a housing; and
one or more electrically conductive materials.

47. The electrical connector of claim 46 wherein the one or more electrically conductive materials is fixed relative to the housing.

48. The electrical connector of claim 46 wherein the one or more electrically conductive materials include one or more receptacles.

49. The electrical connector of claim 48 wherein the one or more receptacles have a discontinuous circumference.

50. The electrical connector of claim 48 wherein the one or more receptacles have a continuous circumference.

51. The electrical connector of claim 46 wherein the one or more electrically conductive materials include one or more teeth.
